(19) United States
(12) Patent Application Publication
(10) Pub. No.: US 2007/0160178 A1
(43) Pub. Date: Jul. 12, 2007

(54) Electrical enclosure, structural assembly, and insert therefor

(75) Inventors: Steven D. Walker, Etowah, NC (US); Soroush Adib, Asheville, NC (US)

Correspondence Address: MARTIN J. MORAN, ESQ.;Eaton Electrical, Inc., Technology & Quality Center, 170 Industry Drive, RIDC Park West, Pittsburgh, PA, 15275-1032, US

(73) Assignee: EATON CORPORATION

(21) Appl. No.: 11/330,020

(22) Filed: Jan. 11, 2006

(51) Int. Cl. G21C 3/10

(52) U.S. Cl. 376/451

(57) ABSTRACT

An insert is for the structural assembly of an electrical enclosure. The structural assembly includes a channel member having a generally flat portion with an aperture and a retaining mechanism, a side sheet coupled to the channel member, and a fastener coupling the channel member to the side sheet. The insert includes a first end portion inserted into the aperture and abutting the side sheet, a second end portion distal from the first end portion, a shoulder portion proximate the second end portion and being engaged by the retaining mechanism, and a tapered portion between the first end portion and the shoulder portion. An axial opening extends through the first end portion, the tapered portion, and the second end portion in order to receive the fastener. Tabs and corresponding notches facilitate proper assembly of the electrical enclosure and the fastener secures the electrical enclosure, once assembled.

### BACKGROUND OF THE INVENTION

1. Field of the Invention

The present invention relates generally to electrical enclosures and, more particularly, to structural assemblies for electrical enclosures, such as excitation controller enclosures. The invention also relates to inserts for the structural assembly of an electrical enclosure.

2. Background Information

Electrical equipment, such as, for example and without limitation, an excitation controller, is typically mounted in an electrical enclosure.

FIG. 1A shows an electrical enclosure 2 which could be used, for example, to house an excitation controller (not shown). The enclosure 2 comprises a frame assembly 4 including a pair of opposing sides 6,8 with a pair of generally parallel wheel tracks 10,12 that are interconnected by a supporting brace 14. The tracks 10,12 allow the controller to be inserted and withdrawn from the enclosure 2. At least one side 6 of the frame assembly 4 includes a top 16, a bottom 18, and first and second structural upright assemblies 20,22 extending therebetween.

Sides 6,8 are connected by structural upright assemblies 20,22 which, as shown in FIG. 1B, generally comprise a first channel member 24,26 and a second channel member 28,30, and a side sheet 32, which is disposed between the channel members 24,28 and 26,30. Conventionally, the channel members, for example, first channel member 26 and second channel member 30, are welded to the side sheet 32. However, this results in spaces or voids 34,36 (best shown in FIG. 1C) between the channel members 24,28 and the side sheet 32 which have unfinished surfaces that will rust if left unpainted.

Painting or otherwise suitably coating the enclosure parts before welding is not practicable because the heat of the welding process melts or burns off the paint. Dipping the welded assembly after welding is an option, but it does not yield the desired uniform and durable finish. It is generally agreed that powder coating yields the most desirable durable finish. However, the powder coating process involves a spray and bake type of process wherein the aforementioned blind areas or voids (e.g., voids 34 and 36 of FIGS. 1B and 1C) are not accessible and, therefore, do not get sufficiently coated.

In an attempt to overcome the aforementioned disadvantages associated with welding together the components of the enclosure, this has largely been replaced by fastening the components together using mechanical fasteners, after the components have been painted or powder coated. Specifically, as shown in FIG. 1C, mechanical fastening of the enclosure frame components involves forming dimples 38 in the first and second channel members 24,28 and side sheet 32, and then bolting the components together using two bolts 40 and a coupling nut 42 at each set of dimples 30. Thus, the bolts 40 and coupling nut 42 are hidden inside the dimples 38 to prevent interference with other components (not shown in FIG. 1C) that are to be mounted flush with the channel members 24,28 and/or side sheet 32. However, tearing can occur at or about the dimples 38 depending on the type and quality of the material used, and the channel members 24,28 can warp and bow resulting in unusable parts. This can be cost intensive both in terms of labor and scrap material.

There is, therefore, room for improvement in electrical enclosures, and in structural assemblies for electrical enclosures.

### SUMMARY OF THE INVENTION

These needs and others are met by the present invention, which is directed to an electrical enclosure including a structural assembly having a plurality of inserts wherein the components of the assembly are mechanically joined.

As one aspect of the invention, an insert is provided for a structural assembly of an electrical enclosure. The structural assembly includes a channel member, a side sheet, and a fastener for coupling the channel member to the side sheet. The channel member includes an aperture having a retaining mechanism. The insert comprises: a first end portion structured to be inserted into the aperture of the channel member and to be disposed at or about the side sheet; a second end portion disposed distal from the first end portion; a shoulder portion disposed proximate the second end portion and structured to be engaged by the retaining mechanism of the aperture of the channel member; and a third portion generally extending between the first end portion and the shoulder portion. The insert includes an axial opening which extends through the first end portion, the second end portion, and the third portion, and is structured to receive the fastener.

The fastener may comprise a threaded fastener including at least one of an enlarged head, a washer, and a nut, and the axial opening may further comprise a counter-bore coaxial with the axial opening and structured to receive at least one of the enlarged head, the washer, and the nut of the threaded fastener therein. The retaining mechanism of the aperture of the channel member may include at least one protrusion wherein, when the insert is fully inserted within the aperture of the channel member, the first end portion abuts the side sheet and the protrusion engages the shoulder portion in order to retain the insert. The first end portion may have a first diameter and the second end portion may have a second diameter wherein the second diameter is larger than the first diameter in order that the second end portion engages the channel member at or about the aperture thereof. The third portion may comprise a tapered portion which forms an angle with respect to the axial opening of between about 5 degrees and about 20 degrees.

As another aspect of the invention, a structural assembly is provided for an electrical enclosure. The structural assembly comprises: a channel member including a generally flat portion having at least one aperture with a retaining mechanism; a side sheet; a fastener coupling the channel member to the side sheet; and an insert comprising: a first end portion inserted into one of the at least one aperture of the channel member and abutting the side sheet, a second end portion disposed distal from the first end portion, a shoulder portion disposed proximate the second end portion and being engaged by the retaining mechanism of the one of the at least one aperture of the channel member, and a tapered portion generally extending between the first end portion and the shoulder portion, wherein the insert includes an axial opening extending through the first end portion, the tapered portion, and the second end portion in order to receive the fastener.

The retaining mechanism may comprise a generally star-shaped cutout including a plurality of protrusions which engage the shoulder portion of the insert and wherein when the insert is fully inserted within the one of the at least one aperture and the retaining mechanism engages the shoulder, the second end portion of the insert is substantially flush with respect to the generally flat portion of the channel member.

At least one of the channel member and the side sheet may include a plurality of tabs, and at least one of the channel member and the side sheet may include a plurality of corresponding notches wherein the tabs are received in the corresponding notches in order to couple the structural assembly together and to facilitate proper assembly thereof.

The structural assembly may be a single-stack assembly wherein the side sheet of the single-stack assembly is a single side sheet and wherein the channel member of the single-stack assembly includes a pair of channel members coupled to one side of the single side sheet. In the single-stack structural assembly, each of the channel members may include a plurality of apertures wherein the insert is disposed within one of the apertures and the fastener is inserted through the insert and the single side sheet in order to secure the single-stack assembly together. Alternatively, the structural assembly may be a double-stack assembly wherein the side sheet of the double-stack assembly is a single side sheet, wherein the channel member of the double-stack assembly includes first and second pairs of channel members, wherein the first pair of channel members is coupled to one side of the single side sheet, and wherein the second pair of channel members is coupled on another side of the single side sheet, opposite the first pair of channel members. In the double-stack structural assembly each of the channel members may include a plurality of apertures wherein the apertures of the first pair of channel members generally align opposite the apertures of the second pair of channel members, and the insert is disposed within one of the apertures of the first pair of channel members and another insert is disposed within a corresponding one of the apertures of the second pair of channel members. The fastener is then inserted through the insert of the first pair of channel members, through the single side sheet, and through the other insert in order to secure the double-stack assembly together.

As another aspect of the invention, an electrical enclosure comprises: a first frame; a second frame disposed opposite and distal from the first frame; and a structural assembly interconnecting and supporting the first frame and the second frame, the structural assembly including a channel member having a generally flat portion with at least one aperture and a retaining mechanism, a side sheet coupled to the channel member, a fastener coupling the channel member to the side sheet, and an insert comprising: a first end portion inserted into one of the at least one aperture of the channel member and abutting the side sheet, a second end portion disposed distal from the first end portion, a shoulder portion disposed proximate the second end portion and being engaged by the retaining mechanism of the channel member, and a tapered portion generally extending between the first end portion and the shoulder portion, wherein the insert includes an axial opening extending through the first end portion, the tapered portion, and the second end portion in order to receive the fastener.

The insert may generally extend between the side sheet and the generally flat portion of the channel member in order to provide rigidity to the electrical enclosure.

### BRIEF DESCRIPTION OF THE DRAWINGS

A full understanding of the invention can be gained from the following description of the preferred embodiments when read in conjunction with the accompanying drawings in which:

FIG. 1A is an isometric view of an excitation control enclosure;

FIG. 1B is a close-up, isometric view of a top corner portion of one side of the excitation control enclosure of FIG. 1A, shown partially cut-away to illustrate internal structures;

FIG. 1C is a cross-sectional view taken along line 1C-1C of FIG. 1A;

FIG. 2 is an exploded isometric view of the top portion of a double-stack structural assembly and inserts therefor, for an excitation control enclosure in accordance with the present invention;

FIG. 3 is an exploded elevational view of a portion of a single-stack structural assembly in accordance with an embodiment of the invention, with one of the inserts therefor shown in the uninstalled position in solid line drawing and in the installed position in phantom line drawing;

FIG. 4 is a cross-sectional assembled view of the top corner portion of the structural assembly of FIG. 2; and

FIG. 5 is an isometric view of an electrical enclosure having the double-stack structural assembly of FIG. 2.

### DESCRIPTION OF THE PREFERRED EMBODIMENTS

For purposes of illustration, the invention will be described as applied to the structural assembly for an electrical enclosure for an excitation controller, although it will become apparent that it could also be applied to structural assemblies for other types of electrical enclosures (e.g., without limitation, switchgear mounting racks), and to other structural assemblies generally.

Directional phrases used herein, such as, for example, left, right, top, bottom and derivatives thereof, relate to the orientation of the elements shown in the drawings and are not limiting upon the claims unless expressly recited therein.

As employed herein, the term “fastener” refers to any suitable connecting or tightening mechanism expressly including, but not limited to, screws, bolts and the combinations of bolts and nuts (e.g., without limitation, lock nuts) and bolts, washers and nuts.

As employed herein, the statement that two or more parts are “coupled” together shall mean that the parts are joined together either directly or joined through one or more intermediate parts.

As employed herein, the term “number” shall mean one or more than one (i.e., a plurality).

As employed herein, the phrase “double-stack” refers to an assembly consisting of a sheet member (e.g., a side sheet) and structural members on either side of, and coupled to, the sheet member. For example, the exemplary double-stack structural assembly of the invention comprises a side sheet, a first pair of channel members coupled to one side of the side sheet, and a second pair of channel members coupled to another side of the side sheet, opposite the first pair of channel members.

Accordingly, the phrase “single-stack” refers to an assembly consisting of a sheet member and structural members coupled to only one side of the sheet member.

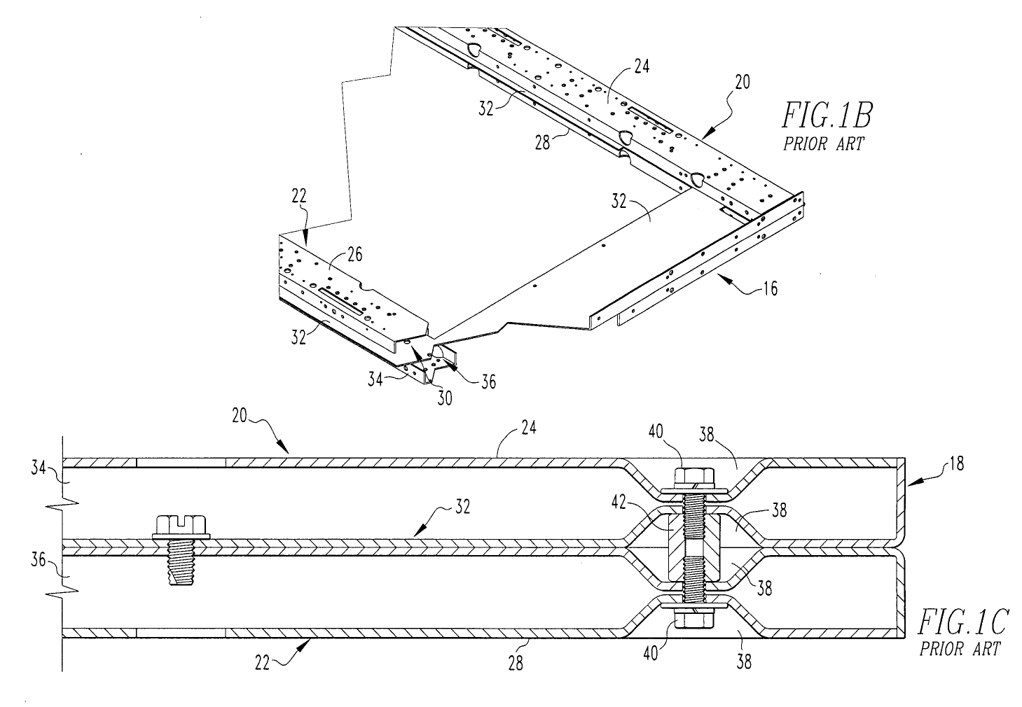

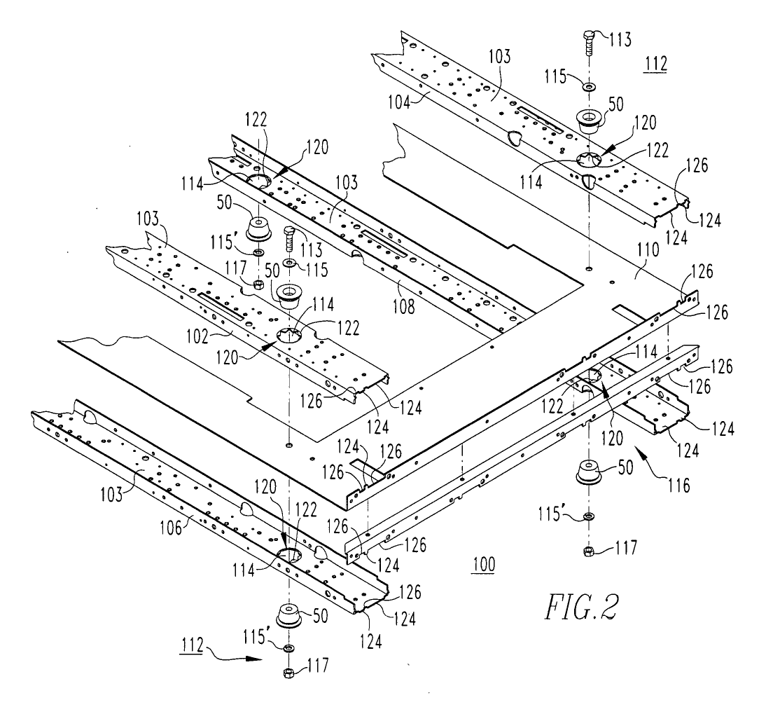

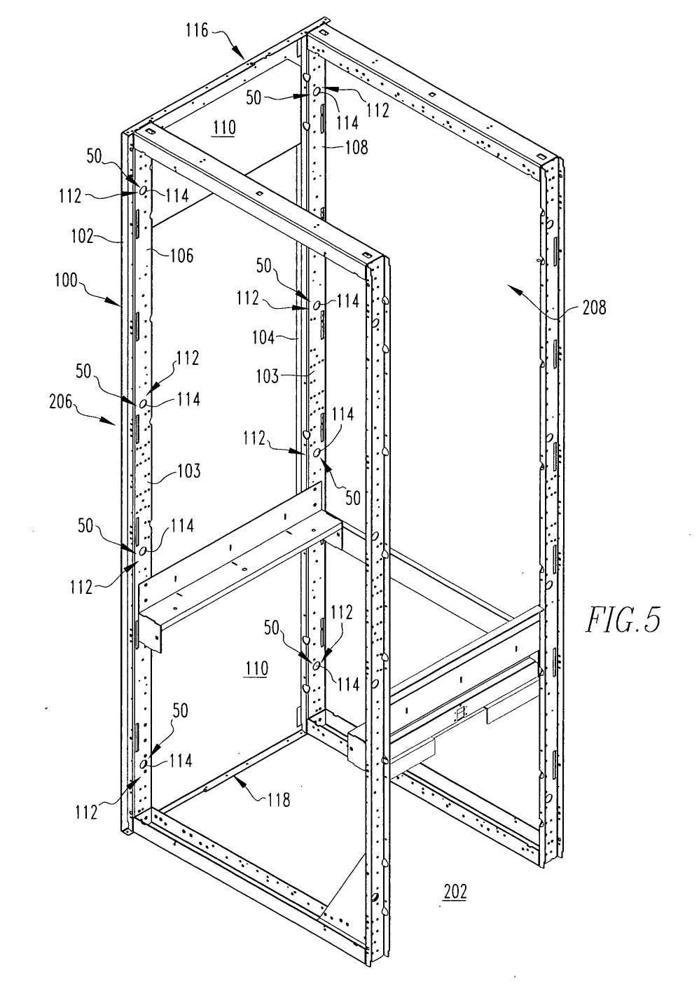

FIG. 2 shows an exploded view of a structural assembly 100 for an electrical enclosure 202 (FIG. 5) in accordance with the invention. The structural assembly in the example of FIG. 2 is a double-stack assembly 100 and employs a plurality of inserts 50. The inserts 50, as best shown in FIG. 3, include a first end portion 52, a second end portion 54 disposed distal from the first end portion 52, a shoulder portion 56 disposed approximate the second end portion 54, a third portion 58 generally extending between the first end portion 52 and shoulder portion 56, and an axial opening 60 extending through the first end portion 52, the second end portion 54, and the third portion 58 in order to receive a fastener 112.

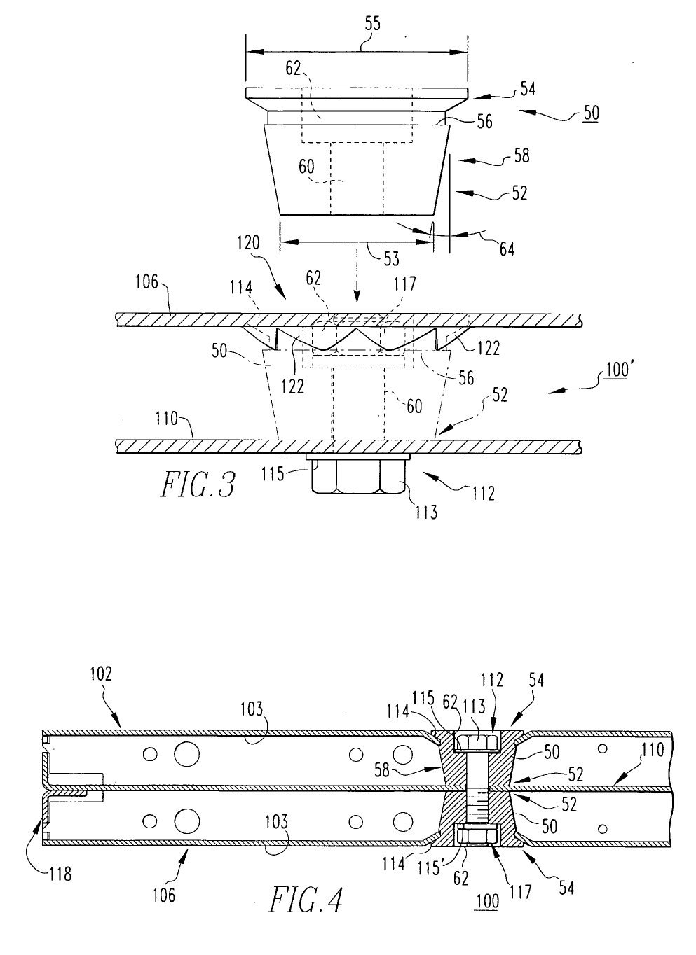

In the examples shown and described herein, the fastener comprises a threaded fastener 112 including at least one of an enlarged head 113, a washer 115, and a nut 117. The axial opening 60 includes a co-axial counter-bore 62 which is structured to receive at least one of the enlarged head 113, the washer 115, and the nut 117 of the threaded fastener 112. In the example of FIG. 3, where the insert 50 is shown in the fully inserted position in phantom line drawing, the nut 117 is disposed within counter-bore 62, and in the example of FIG. 4, which is shown in cross-sectional view, the enlarged head 113 and a first washer 115, are disposed within counter-bore 62 of one insert 50 while the nut and a second, lock washer 115′, are disposed in the counter-bore 62 of another insert 50. It will, however, be appreciated that any known or suitable fastener could be employed to secure the structural assembly 100 (FIGS. 2, 4 and 5), 100′ (FIG. 3) together.

In the example of FIG. 2, the double-stack structural assembly 100 includes channel members 102,104,106,108 each having a generally flat portion 103 with at least one aperture 114 having a retaining mechanism 120. The structural assembly 100 further includes a side sheet 110 which, in the double-stack example of FIG. 2, is sandwiched between the first and second pairs of channel members 102,104,106,108. The retaining mechanism 120 at each aperture 114 comprises a generally star-shaped cutout 120 including a plurality of protrusions 122. The protrusions 122 are structured to engage the insert 50 at the shoulder portion 56 thereof. Accordingly, when the insert 50 is fully inserted as shown in FIG. 3 (phantom line drawing) and FIG. 4, the first end portion 52 of the insert abuts the side sheet 110, and the protrusions 122 of the generally star-shaped cutout 120 engage the shoulder portion 56. Thus, when the insert 50 is fully inserted, it substantially extends between the side sheet 110 and the generally horizontal portion 103 of the channel members (e.g., channel members 102 and 106 of FIG. 4) in order to provide rigidity to the structural assembly 100 and thus to the electrical enclosure 202 (FIG. 5) in general.

The third portion 58 (best shown in FIG. 3) of the insert 50 is tapered in order to facilitate insertion of the insert 50 into apertures 114 of the channel members 102,104,106,108. As shown in FIG. 3, the tapered portion 58, which generally extends between the first end portion 52 and the shoulder portion 56 of insert 50, forms an angle 64 with respect to the axial opening 60 of the insert 50. The exemplary angle 64 is preferably between about 5 degrees and about 20 degrees, and more preferably is about 10 degrees, although it will be appreciated that any suitable alternative angle or insert configuration could be employed without departing from the scope of the invention.

Referring to FIGS. 3 and 4, it will be understood that the first end portion 52 of insert 50 has a first diameter 53 while the second end portion 54 has a second diameter 55, which is larger than the first diameter 53. As best shown in FIG. 4, this enables the second end portion 54 to engage the channel member 102,106 at or about the aperture 114 thereof.

In comparing FIGS. 2 and 4 to FIG. 3, it will be appreciated that the structural assembly in accordance with the invention can comprise either the double-stack assembly 100, shown in FIGS. 2 and 4, or the single-stack assembly 100′, shown in FIG. 3. In the single-stack assembly 100′ the channel members (one channel 106 is shown in FIG. 3) are coupled to one side of the single side sheet 110 using fastener 112 disposed through insert 50 (shown in phantom line drawing in the inserted position in FIG. 3). More specifically, the insert 50 is disposed within the aperture 114 of channel member 106 such that the first end portion 52 abuts side sheet 110 and the protrusions 122 of the generally star-shaped retaining mechanism 120 engage shoulder portion 56, in order to retain the insert between the side sheet 110 and channel member 106. The fastener 112 is then inserted through the insert 50 and the single side sheet 110 in order to secure the single-stack assembly 100′ together. It will be appreciated that in the single-stack assembly 100′, as well as the double-stack assembly 100 (FIGS. 2 and 4), each of the channel members (e.g., 106) may include more than one (e.g., a plurality) of apertures 114 and inserts 50 disposed therein.

The double-stack assembly 100, as shown in FIGS. 2, 4 and 5, and as previously discussed, includes first and second pairs of channel members 102,104,106,108 coupled to opposing sides of side sheet 110. Accordingly, as best shown in FIG. 4, in operation, an insert 50 is disposed within one of the apertures 114 of a channel member 106 of the first pair of channel members 106,108 (FIGS. 2 and 5) and another insert 50 is disposed within a corresponding one of the apertures 114 of the second pair of channel members (see, for example, aperture 114 of channel member 102 in FIG. 4). The fastener 112 is then inserted through the insert 50 of the first pair of channel members 106,108 (FIG. 2), through the single side sheet 110, and through the other insert 50 in order to secure the double-stack assembly 100 in a configuration where the second end portions 54 of inserts 50 are substantially flush with the generally horizontal portions 103 of channel members 102 and 106. In this manner, both the single-stack assembly 100′ (FIG. 3) and double-stack assembly 100 (FIGS. 2, 4 and 5) of the invention enable the separate components of the structural assemblies to be first coated (e.g., without limitation painted or powder coated) substantially uniformly, and then subsequently mechanically secured together.

Another aspect of the invention, which functions to facilitate proper assembly of the electrical enclosure 202 (FIG. 5), is a unique interlocking tab and corresponding notch configuration. Specifically, the channel members 102,104,106,108 and/or the side sheet 110 include a plurality of tabs 124, and the channel members 102,104,106,108 and/or the side sheet 110 include a plurality of corresponding notches 126 wherein the tabs 124 are received in the corresponding notches 126 (best shown in the unassembled view of FIG. 2) in order to couple the structural assembly 100 together and to facilitate proper assembly thereof. In other words, in the example of FIG. 2, the channel members 102,104,106,108 and the side sheet 110 both include tabs 124 and corresponding notches 126 which interconnect with one another when the structural assembly 100 is coupled together. The fasteners 112 are then inserted and tightened in order to further secure the assembly together. It will, however, be appreciated that any known or suitable alternative interconnecting mechanism or configuration could be employed. For example, without limitation, only one of the channel members 102,104,106,108 or the side sheet 110, could have tabs 124 while the other of the channel members 102,104,106,108 and the side sheet 110 has the corresponding notches 126.

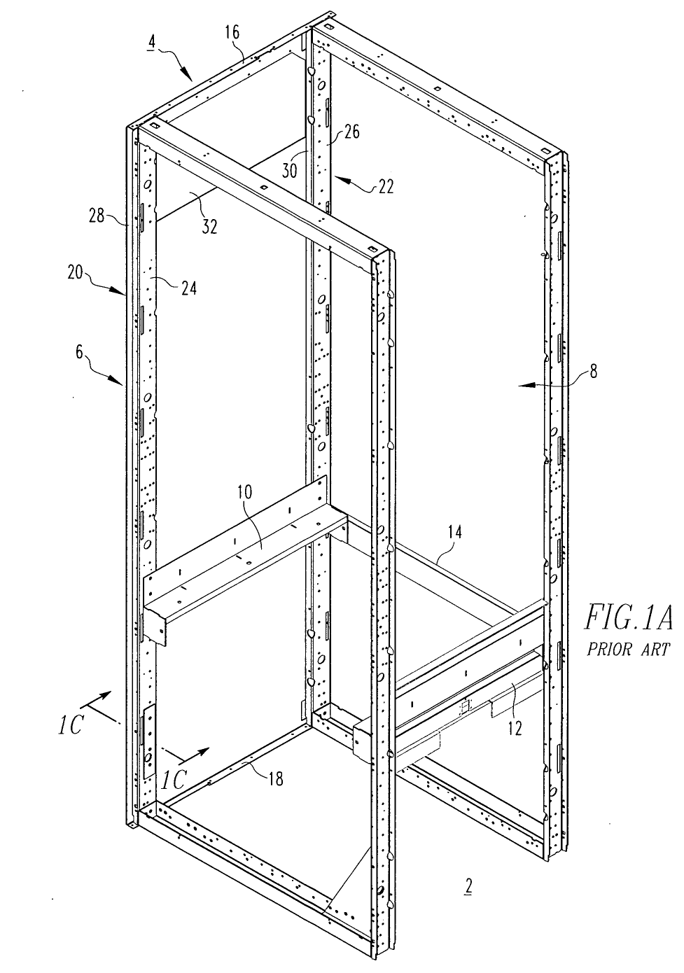

FIG. 5 illustrates the electrical enclosure 202 employing the double-stack structural assembly 100 of the invention (oriented on the left side of electrical enclosure 202 in FIG. 5). With the exception of the improved structural assembly 100 of the invention, certain features of the electrical enclosure 202 of FIG. 5 are substantially similar to the electrical enclosure 2 shown and previously discussed in connection with FIG. 1A. In the example of FIG. 5, the electrical enclosure 202 includes a first frame 206, a second frame 208 disposed opposite and distal from the first frame 206, and the structural assembly 100, which interconnects and supports the first and second frames 206,208. The electrical enclosure 202 further includes a top 116 and a bottom 118 (both from the perspective of FIG. 5). The first and second frames 206,208 include edge members 106,108, respectively, wherein the edge members 106,108 comprise the first pair of channel members 106,108, respectively, of the structural assembly 100. Accordingly, in the double-stack assembly 100 of FIG. 5, the edge members 106,108 are coupled to one side of side sheet 110 and the second pair of channel members 102,104 are disposed opposite such edge members 106,108, on the opposite side of side sheet 110. The entire assembly is then secured together using the aforementioned plurality of inserts 50 disposed in apertures 114 and secured through use of the fasteners 112, as previously discussed.

Although the double-stack assembly 100 is shown in FIG. 5, it will be appreciated that the single-stack assembly 100′, as discussed hereinbefore in connection with FIG. 3, could also be employed as part of the electrical enclosure 202, or in place of the double-stack assembly 100, shown. In instances where the single-stack assembly 100′ (FIG. 3) is employed instead of double-stack assembly 100, the edge members 106,108 of frames 206,208 would comprise the pair of channel members 106,108 of the single-stack assembly 100′, as previously discussed.

Accordingly, the electrical enclosure and structural assembly, and insert therefor in accordance with the invention, enable sufficient coating (e.g., without limitation, painting or powder coating) of the components of the electrical enclosure to resist corrosion thereof, and furthermore provide a strong, rigid assembly which resists tearing, bowing and warping while having a flush-mount finish which is aesthetically pleasing and preferred.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. An insert for a structural assembly of an electrical enclosure, said structural assembly including a channel member, a side sheet, and a fastener for coupling said channel member to said side sheet, said channel member including an aperture having a retaining mechanism, said insert comprising:
a first end portion structured to be inserted into the aperture of said channel member and to be disposed at or about said side sheet;
a second end portion disposed distal from the first end portion;
a shoulder portion disposed proximate the second end portion and structured to be engaged by said retaining mechanism of the aperture of said channel member; and
a third portion generally extending between the first end portion and said shoulder portion,
wherein said insert includes an axial opening extending through the first end portion, the second end portion, and the third portion, said axial opening being structured to receive said fastener.

2. The insert of claim 1 wherein said fastener comprises a threaded fastener including at least one of an enlarged head, a washer, and a nut; and wherein said axial opening further comprises a counter-bore coaxial with said axial opening and structured to receive at least one of said enlarged head, said washer, and said nut of said threaded fastener therein.

3. The insert of claim 1 wherein said retaining mechanism of the aperture of said channel member includes at least one protrusion; and wherein, when said insert is fully inserted within the aperture of said channel member, the first end portion abuts said side sheet and said at least one protrusion engages said shoulder portion in order to retain said insert.

4. The insert of claim 1 wherein the first end portion has a first diameter; wherein the second end portion has a second diameter; and wherein the second diameter is larger than the first diameter in order that the second end portion engages said channel member at or about the aperture thereof.

5. The insert of claim 1 wherein the third portion comprises a tapered portion; and wherein said tapered portion forms an angle with respect to said axial opening of between about 5 degrees and about 20 degrees.

6. A structural assembly for an electrical enclosure, said structural assembly comprising:
a channel member including a generally flat portion having at least one aperture with a retaining mechanism;
a side sheet;
a fastener coupling said channel member to said side sheet; and
an insert comprising:
a first end portion inserted into one of said at least one aperture of said channel member and abutting said side sheet,
a second end portion disposed distal from the first end portion,
a shoulder portion disposed proximate the second end portion and being engaged by said retaining mechanism of said one of said at least one aperture of said channel member, and
a tapered portion generally extending between the first end portion and said shoulder portion,
wherein said insert includes an axial opening extending through the first end portion, said tapered portion, and the second end portion in order to receive said fastener.

7. The structural assembly of claim 6 wherein said retaining mechanism comprises a generally star-shaped cutout including a plurality of protrusions which engage said shoulder portion of said insert; and wherein when said insert is fully inserted within said one of said at least one aperture and said retaining mechanism engages said shoulder, the second end portion of said insert is substantially flush with respect to said generally flat portion of said channel member.

8. The structural assembly of claim 6 wherein at least one of said channel member and said side sheet includes a plurality of tabs; wherein at least one of said channel member and said side sheet includes a plurality of corresponding notches; and wherein said tabs are received in said corresponding notches in order to couple the structural assembly together and to facilitate proper assembly thereof.

9. The structural assembly of claim 6 wherein said structural assembly is a single-stack assembly; wherein said side sheet of said single-stack assembly is a single side sheet; and wherein said channel member of said single-stack assembly includes a pair of channel members coupled to one side of said single side sheet.

10. The structural assembly of claim 9 wherein each of said channel members includes as said at least one aperture, a plurality of apertures; wherein said insert is disposed within one of said apertures; and wherein said fastener is inserted through said insert and said single side sheet in order to secure said single-stack assembly together.

11. The structural assembly of claim 6 wherein said structural assembly is a double-stack assembly; wherein said side sheet of said double-stack assembly is a single side sheet; wherein said channel member of said double-stack assembly includes first and second pairs of channel members; wherein said first pair of channel members is coupled to one side of said single side sheet; and wherein said second pair of channel members is coupled on another side of said single side sheet, opposite said first pair of channel members.

12. The structural assembly of claim 11 wherein each of said channel members includes as said at least one aperture, a plurality of apertures; wherein the apertures of said first pair of channel members generally align opposite the apertures of said second pair of channel members; wherein said insert is disposed within one of the apertures of said first pair of channel members and another insert is disposed within a corresponding one of the apertures of said second pair of channel members;
and wherein said fastener is inserted through said insert of said first pair of channel members, through said single side sheet, and through said other insert in order to secure said double-stack assembly together.

13. An electrical enclosure comprising:
a first frame;
a second frame disposed opposite and distal from said first frame; and
a structural assembly interconnecting and supporting said first frame and said second frame, said structural assembly including a channel member having a generally flat portion with at least one aperture and a retaining mechanism, a side sheet coupled to said channel member, a fastener coupling said channel member to said side sheet, and an insert comprising:
a first end portion inserted into one of said at least one aperture of said channel member and abutting said side sheet,
a second end portion disposed distal from the first end portion,
a shoulder portion disposed proximate the second end portion and being engaged by said retaining mechanism of said channel member, and
a tapered portion generally extending between the first end portion and said shoulder portion,
wherein said insert includes an axial opening extending through the first end portion, said tapered portion, and the second end portion in order to receive said fastener.

14. The electrical enclosure of claim 13 wherein said insert generally extends between said side sheet and said generally flat portion of said channel member in order to provide rigidity to said electrical enclosure.

15. The electrical enclosure of claim 13 wherein said retaining mechanism comprises a generally star-shaped cutout including a plurality of protrusions which engage said shoulder portion of said insert; and wherein when said insert is fully inserted within said one of said at least one aperture and said retaining mechanism engages said shoulder portion, the second end portion of said insert is substantially flush with respect to said generally flat portion of said channel member.

16. The electrical enclosure of claim 13 wherein said first and second frames each include an edge member; wherein at least one of said channel member, said side sheet, and said edge member includes a plurality of tabs; wherein at least one of said channel member, said side sheet, and said edge member includes a plurality of corresponding notches; and wherein said tabs are received in said corresponding notches in order to couple said structural assembly together and to said first and second frames, and to facilitate proper assembly of said electrical enclosure.

17. The electrical enclosure of claim 13 wherein said structural assembly is a single-stack assembly; wherein said side sheet of said single-stack assembly is a single side sheet; wherein said first and second frames include edge members; and wherein said channel member of said single-stack assembly comprises a pair of said edge members of said first and second frames, which are coupled to one side of said single side sheet.

18. The electrical enclosure of claim 17 wherein each of said edge members includes as said at least one aperture, a plurality of apertures; wherein said insert is disposed within one of said apertures; and wherein said fastener is inserted through said insert and said single side sheet in order to secure said single-stack assembly together.

19. The electrical enclosure of claim 13 wherein said structural assembly is a double-stack assembly; wherein said side sheet of said double-stack assembly is a single side sheet; wherein said first and second frames include edge members; wherein said channel member of said double-stack assembly includes first and second pairs of channel members; wherein said first pair of channel members comprises said edge members of said first and second frames, which are coupled to one side of said single side sheet; and wherein said second pair of channel members is coupled to another side of said single side sheet, opposite said edge members.

20. The electrical enclosure of claim 19 wherein said channel members and said edge members include as said at least one aperture, a plurality of apertures; wherein the apertures of said edge members generally align opposite the apertures of said second pair of channel members; wherein said insert is disposed one of the apertures of said edge members and another insert is disposed within a corresponding one of the apertures of said second pair of channel members; and wherein said fastener is inserted through said insert of said edge members, through said single side sheet, and through said other insert in order to secure said double-stack assembly together.
